(19) United States
(12) Patent Application Publication
(10) Pub. No.: US 2018/0101870 A1
(43) Pub. Date: Apr. 12, 2018

(54) METHODS, SYSTEMS, AND COMPUTER READABLE MEDIA FOR THE BROADCAST AND EXCHANGE OF ELECTRONIC CERTIFICATES BETWEEN DIGITAL WALLETS

(71) Applicant: MasterCard International Incorporated, Purchase, NY (US)

(72) Inventor: Manoneet Kohli, O'Fallon, MO (US)

(21) Appl. No.: 15/288,479

(22) Filed: Oct. 7, 2016

(51) Int. Cl. G06Q 30/02

(52) U.S. Cl. CPC G06Q 30/0267; G06Q 30/0275; G06Q 20/36; G06Q 30/0255; G06Q 30/0261

(57) ABSTRACT

Exemplary systems, methods, and computer readable media for the broadcast and exchange of electronic certificates between digital wallets are provided. Exemplary systems and methods include and/or are preformed by an electronic certificate exchange and bidding manager (ECEBM). The ECEBM receives an offer to sell an electronic certificate stored in a first digital wallet. The ECEBM receives subscriber data, analyzes the subscriber data for determining a broadcast pool of subscribers corresponding to a subset of the plurality of subscribers, broadcasts details regarding the offer to sell the electronic certificate to the broadcast pool of subscribers, and analyzes buyer preferences received from at least some of the broadcast pool of subscribers for determining a second digital wallet to receive the electronic certificate. The ECEBM instructs a wallet manager to transfer the electronic certificate from the first digital wallet to the second digital wallet.

### TECHNICAL FIELD

The subject matter described herein relates generally to computer systems for the broadcast and exchange of electronic certificates, such as electronic coupons, gift cards, rebates, rewards, offers, or the like. More particularly, the subject matter described herein relates to methods, systems, and computer readable media for the broadcast and exchange of electronic certificates between digital wallets of subscribers.

### BACKGROUND

Gift cards have become easy, go-to gifts that one person may give to another in a variety of situations. However, tangible gift cards suffer from many of the constraints associated with traditional gifts. For example, buying the gift card may necessitate a visit to the merchant or a wait on shipping of the card. As a result, many merchants have begun to offer electronic gift card certificates.

Merchants, advertisers, and/or other providers have long offered other, various other types of electronic certificates to consumers. For example, providers offer consumers various options in redeeming electronic certificates including coupons, offers, rebates, rewards, loyalty cards, and the like.

Electronic certificates can be implemented in different ways, for example, such as a sequence of alphanumeric characters and/or alphanumeric characters encoded as optical machine-readable representations of data (e.g., barcodes). One or more electronic certificates may be stored in a consumer's digital wallet until being redeemed. However, the electronic certificates may go unused for long periods of time. As a result, the value of many electronic certificates, such as electronic gift card certificates, may go unused and never be realized by the recipient.

Some electronic certificates go unused for other reasons. For example, certificate providers may send out certificates to consumers that lack an interest in for example, the electronic coupon or offer.

To date, there is not a method or system by which the electronic certificates in a consumer's digital wallet may be broadcast and/or securely exchanged with other users. Thus, a high percentage of electronic certificates go unused.

Accordingly, a need exists for methods, systems, and computer readable media for the broadcast and exchange of electronic certificates between digital wallets of consumers.

### SUMMARY

The subject matter described herein relates to methods, systems, and computer readable media for the broadcast and exchange of electronic gift cards between digital wallets.

In an exemplary embodiment, a method for the broadcast and exchange of electronic certificates between digital wallets comprises receiving, at an electronic certificate exchange and bidding manager (ECEBM), an offer to sell an electronic certificate stored in a first digital wallet. The method further comprises receiving, at the ECEBM, subscriber data associated with a plurality of subscribers and analyzing the subscriber data for determining a broadcast pool of subscribers corresponding to a subset of the plurality of subscribers. The method further includes broadcasting details regarding the offer to sell the electronic certificate to the broadcast pool of subscribers, analyzing buyer preferences received from at least some of the broadcast pool of subscribers, determining a second digital wallet to receive the electronic certificate, and instructing a wallet manager to transfer the electronic certificate from the first digital wallet to the second digital wallet.

In an exemplary embodiment, a system for the broadcast and exchange of electronic certificates between digital wallets comprises at least one processor and an exchange and bidding matching engine (EBME) implemented on the at least one processor. The EBME is configured to receive an offer to sell an electronic certificate stored in a first digital wallet, receive subscriber data associated with a plurality of subscribers, analyze, the subscriber data for determining a broadcast pool of subscribers corresponding to a subset of the plurality of subscribers, broadcast details regarding the offer to sell the electronic certificate to the broadcast pool of subscribers, analyze buyer preferences received from at least some of the broadcast pool of subscribers, determine a second digital wallet to receive the electronic certificate, and instruct a wallet manager to transfer the electronic certificate from the first digital wallet to the second digital wallet.

In some embodiments, receiving an offer to sell an electronic certificate includes receiving an offer to sell an electronic gift card, an electronic coupon, an electronic offer, or an electronic reward.

In some embodiments, receiving an offer to sell an electronic certificate includes receiving seller preferences associated with the offer to sell the electronic certificate. In some embodiments, the seller preferences include an indication of a minimum monetary bid, a maximum monetary bid, or a guaranteed monetary amount that will be accepted as consideration for the electronic certificate.

In some embodiments, receiving subscriber data includes receiving location information, geographic information, global positioning system (GPS) information, a location code, longitude and latitude coordinates, or a zip code.

In some embodiments, receiving subscriber data includes receiving purchase history information for a plurality of wallets associated with the plurality of subscribers.

In some embodiments, analyzing the subscriber data includes analyzing location information or purchase history information associated with the plurality of subscribers. In some embodiments, analyzing the purchase history information includes determining a number of purchases conducted at each of a plurality of different merchants in the purchase history and identifying merchants having a highest number of purchases in the purchase history.

In some embodiments, broadcasting details to the broadcast pool of subscribers includes instructing a broadcast manager to send an alert message, a notification message, a Short Message Service (SMS) message, a Multimedia Messaging Service (MMS) message, or an electronic mail (e-mail) message to individual subscribers in the broadcast pool of subscribers.

In some embodiments, instructing the wallet manager includes sending a first digital wallet identifier, a second digital wallet identifier, and an electronic certificate identifier to the wallet manager, and instructing the wallet manager to disassociate the electronic certificate identifier with the first digital wallet and associate the electronic certificate identifier with the second digital wallet.

The subject matter described in this specification may be implemented in hardware, software, firmware, or combinations of hardware, software and/or firmware. In some examples, the subject matter described in this specification may be implemented using a non-transitory computer readable medium storing computer executable instructions that when executed by one or more processors of a computer cause the computer to perform operations.

Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms.

### BRIEF DESCRIPTION OF THE DRAWINGS

FIG. 1 is a schematic block diagram illustrating exemplary network architecture for facilitating the broadcast and exchange of electronic certificates between digital wallets according to an embodiment of the subject matter described herein;

FIG. 2 is a message diagram illustrating exemplary electronic messaging between various parties involved in the broadcast and exchange of electronic certificates between digital wallets according to an embodiment of the subject matter described herein;

FIG. 3 is a block diagram illustrating an exemplary system for managing the broadcast and exchange of electronic certificates between digital wallets according to an embodiment of the subject matter described herein;

FIGS. 4A-4F are screen shots illustrating user equipment interacting with the system for managing the broadcast and exchange of electronic certificates between digital wallets according to an embodiment of the subject matter described herein; and

FIG. 5 is a block diagram illustrating an exemplary process for the broadcast and exchange of electronic certificates between digital wallets according to an embodiment of the subject matter described herein.

### DETAILED DESCRIPTION

The methods, systems, and computer readable media described herein facilitate the broadcast and exchange of electronic certificates between digital wallets, which improves the functionality of computers and they way computers operate. Improvements are embodied as improvements in security (e.g., the secure exchange of electronic certificates wallet-to-wallet), secure notifications regarding the content of a user's (private) digital wallet, and improved speed of transactions by way of wallet-to-wallet exchanges.

In some embodiments, payload information, including details regarding a sale of one or more electronic certificates residing in a seller's digital wallet, is communicated to an electronic certificate exchange and bidding manager (ECEBM). The payload information (e.g., electronic certificate details, offer details, and/or subscriber preferences) is formulated into a set of criteria and used to configure a pool of potential buyers that may have an interest in buying the one or more electronic certificates offered for sale, and receiving the electronic certificate within in their respective digital wallet. The pool of buyers is sent a notification, in real time, via the packet-based network. The buyers may then individually interact with ECEBM to place electronic bids on the one or more electronic certificates being offered for sale, and initiate a secure wallet-to-wallet exchange thereof.

Electronically publishing the contents of one subscriber's digital wallet to other subscribers, and facilitating the secure wallet-to-wallet exchange of electronic certificates as described herein advantageously obviates the need for performing manual processes (e.g., manual searches relating to offers, gift certificates, rewards, coupons, or the like and/or manual exchanges of offers, rewards, coupons, gift certificates, or the like) and improves the functionality of computers, namely the security and speed thereof.

As used herein, the term “electronic certificate” refers to an electronic coupon, an electronic gift card, an electronic offer, an electronic reward, an electronic rebate, electronic points, an electronic loyalty reward, an electronic gift certificate, an electronic ticket, or any other type of electronic certificate redeemable for money, credit, store merchandise, goods or services, points, tickets, free goods and/or services, or the like.

In some embodiments, electronic certificates include any sequence of alphanumeric characters and/or alphanumeric characters encoded as optical machine-readable representations of data (e.g., barcodes). The electronic certificate includes “content” of a user's digital wallet, which may be offered for sale, broadcast, purchased, and/or exchanged via management of secure wallet-to-wallet transactions and/or communications.

As used herein, the term “location or geographic information” refers to any information that may be associated with a subscriber (consumer) location, a merchant location, a POS location, any offer presentation system or device location, and/or combinations thereof, including, but not limited to the location of the purchase, a location of the subscriber, global positioning system (GPS) location information (e.g., for a merchant, POS, or subscriber), a location code (e.g., for a merchant, POS, or subscriber), longitude/latitude coordinates of the merchant, POS, or subscriber, an ISP or mobile application GPS location of the merchant, POS, or subscriber, a street address of the location, a zip code, or any other detail indicative of a location of a merchant, subscriber, and/or POS.

As used herein, the term “seller preference(s)” and/or “buyer preference(s)” refer to any detail or information associated with a respective user/seller and user/buyer who has “subscribed to” and/or “opted in” to send and receive offers, broadcasts, or the like regarding the notification, sale, transfer, and/or exchange of electronic certificates between respective digital wallets. Seller and buyer preferences may be embodied as packets carrying electronic payload information communicated across a packet network.

For example, seller preferences may include information or details regarding an offer to sell an electronic certificate stored in the seller's respective digital wallet. Seller preferences may include an indication of a minimum “bid” (monetary amount or other consideration) that they would accept for an electronic certificate stored in their digital wallet, a maximum “bid” for an electronic certificate stored in their digital wallet, a “guaranteed” amount that will be automatically accepted as consideration for an electronic certificate stored in their wallet, a preferred payment method, an amount of time in which a buyer has to make a payment (e.g., in minutes, hours, or the like), an amount of time to leave the sale open (e.g., in hours, days, or the like), combinations thereof, or the like. Any other seller preferences may be provided.

Buyer preferences may include an indication of the buyer's interests in electronic certificates (e.g., brands, items, or the like), for which the respective buyer wishes to receive broadcasts, a maximum number of broadcasts to retrieve per a given time (e.g., number of broadcasts per day, etc.), a preferred method of receiving broadcasts (e.g., text messages, Short Message Service (SMS) messages, Multimedia Messaging Service (MMS) messages, alert messages, electronic mail (e-mail) messages, m notification, etc.), the type of electronic certificates that the respective buyer wishes to receive broadcasts for (e.g., electronic coupons, electronic gift cards, electronic points, electronic rewards, electronic offers, or the like). Any other buyer preferences may be provided. In some embodiments, purchase history information and/or location or geographic information is communicated to ECEBM and used to determine potential buyers having interest in an electronic certificate being offered for sale.

In some aspects, ECEBM is configured to receive packets with payloads indicative of seller preferences, buyer preferences, location or geographic information, and/or purchase history information, or the like, and analyze the payloads for determining a purchase history of a pool of potential buyer, determining spending patterns of a pool of buyers, determining locations of potential buyers, configuring a broadcast pool of buyers, and for ultimately matching buyers and sellers of electronic certificates based on respective buyer and seller preferences thereby initiating a secure wallet-to-wallet transfer or exchange of the electronic certificate from the digital wallet of the seller to the digital wallet of the buyer.

As used herein, the terms “buyers” and “sellers” may also be referred to as “consumers”, “users”, and/or “subscribers”.

Reference will now be made in detail to exemplary embodiments of the subject matter described herein, examples of which are illustrated in the accompanying drawings. Wherever possible, the same reference numbers will be used throughout the figures, also “FIGS.”, to refer to the same or like entities.

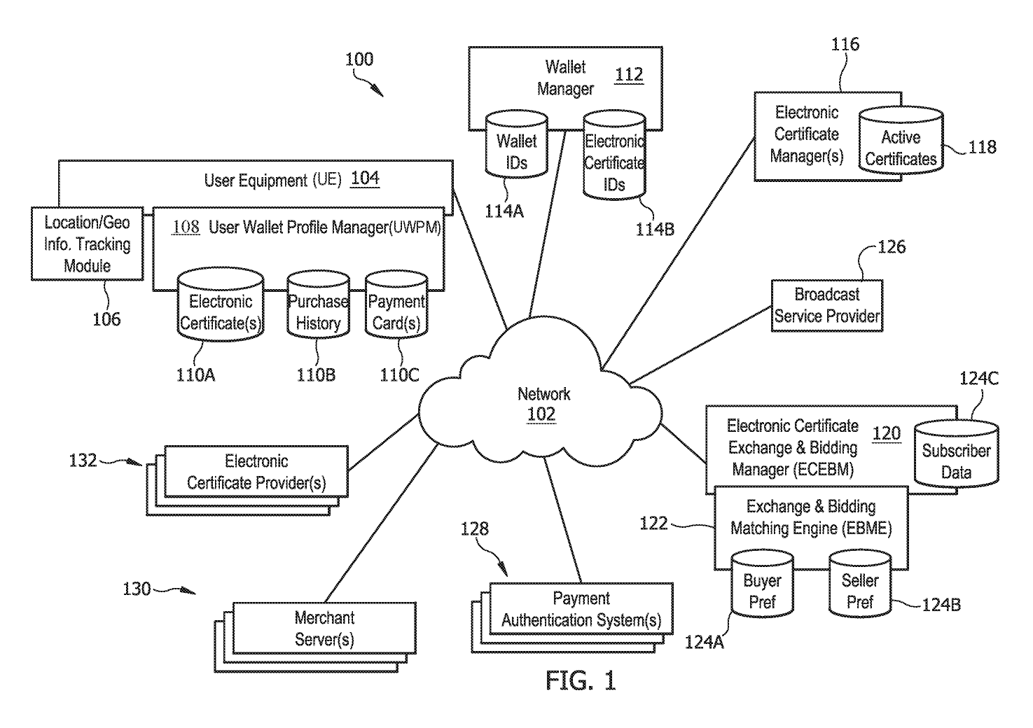

FIG. 1 is a schematic diagram illustrating an exemplary computing and/or network environment or computing and/or network architecture 100 for facilitating the broadcast and exchange of electronic certificates between digital wallets of buyers and sellers.

Multiple entities are configured to access a network 102 for initiating, managing, and facilitating the broadcast and exchange of electrical certificates between digital wallets. For example, entities including user equipment (UE) 104, wallet manager 112, one or more electronic certificate manager(s) 112, one or more electronic certificate managers(s) 116, broadcast service providers 126, ECEBM 120, one or more payment authentication system(s) 128, one or more merchant server(s) 130, and one or more electronic certificate providers 132 may each access network 102 and send or receive packet communications across network 102 for initiating, managing, and facilitating the broadcast and exchange of electrical certificates between digital wallets of different users.

In some embodiments, network 102 is a packet-based communications network (e.g., the Internet) that is accessed by UE 104 via a communications interface. Although not shown, each individual network entity (e.g., 104, 112, 116, 126, 120, 128, 130, and 132) associated with architecture 100 may reside in an individual (e.g., public or private) network, which may include a same network or different networks, and are not shown for illustration purposes. Network 102 facilitates communication of data between network entities via packets or packet-based messages, which may be communicated between network entities described herein according to any desired communication protocol as known in the art, (e.g., IP, HTTP, TCP, UDP, SIP, or the like).

Network 102 may be accessed via one or more access nodes, endpoints, or ingress points such as one or more gateways or switches (not shown). For illustration purposes only, a single network 102 is illustrated for generically depicting the Internet or cloud. Network 102 can support one or more cloud based entities or services, however, as known in the art. Architecture 100 may also include and/or facilitate communications for multiple different (e.g., individual or privately managed) networks and/or communications across multiple different networks for accessing services hosted or provided by various individual entities.

In some embodiments, ECEBM 120 is configured to communicate with a collection of individual network entities (e.g., 104, 112, 116, 126, 128, 130, and 132) to receive an indication that an electronic certificate contained in a first digital wallet is for sale, analyze user preferences to intelligently configure a pool of potential buyers that may have interest in purchasing the electronic certificate being offered for sale, electronically broadcast the sale of the electronic certificate to the pool of potential buyers, receive bids for the electronic certificate, and communicate the identities of the buyer, seller, and electronic certificate to wallet manager 112 thereby initiating the secure payment and wallet-to-wallet transfer of the electronic certificate from the first digital wallet (i.e., the digital wallet of the seller) to a second digital wallet (i.e., the digital wallet of the buyer).

In some embodiments, architecture 100 includes multiple different and/or distinct computing and/or network entities for facilitating the broadcast and exchange of electronic certificates between different digital wallets. Digital wallets may be stored on mobile or non-mobile payment-enabled devices, such as UE 104. Users (e.g., buyers and sellers) utilize respective UEs 104 to subscribe to services offered by ECEBM 120, specify preferences regarding the broadcast and exchange of electronic certificates, and specify preferences regarding a potential sale or purchase of an electronic certificate stored in another user's digital wallet. Respective buyers and sellers each utilize a respective device (e.g., UE 104) for the bidding and wallet-to-wallet exchange of electronic certificates, however only one UE 104 is shown in FIG. 1 for illustration purposes only.

An exemplary UE 104 is embodied as any type of mobile or non-mobile payment-enabled device such as a phone, a computer, a smart device, a laptop computer, a tablet computer, a desktop computer, a smart planner or organizer, a smart television, a wearable computer (e.g., a watch or eyeglasses mounted computer), or the like. UE 104 may access services provided via other network entitles via network 102 upon signaling across any type of wired or wireless connection or interface (e.g., a WAN, a LAN, a Wi-Fi connection, a radio access connection, or the like).

UE 104 may include a location and geographic information tracking module 106 and a user wallet profile manager (UWPM) 108. Users (e.g., buyers, sellers, subscriber, and/or consumers of electronic certificates) may “opt-in” and/or “agree” to share some of the information stored in module 106 and/or UWPM 108 with ECEBM 120 for use by ECEBM 120 in matching sellers of electronic certificates to buyers of electronic certificates. For example, information received at ECEBM 120 from module 106 and/or UWPM 108 may be analyzed at ECEBM 120 to improve the intelligence in matching buyers with sellers by utilizing purchase history information and/or location or geographic information in configuring a pool of potential buyers.

In some embodiments, a buyer UE 104 that is physically located inside of a merchant store may have opted-in to sharing location and/or geographic information from module 106 and, in return, receives real-time notifications or broadcasts relating to the sale of electronic certificates that are redeemable at the visited merchant store upon entering the store.

In some embodiments, module 106 includes one or more tangible machines disposed in UE 104 that are collectively configured to determine the location of UE 104. For example, module 106 may include a combination of inertial sensors, a compass (e.g., or magnetometer), an accelerometer, and/or a gyroscope to determine a location of UE 104. Other modules, machines, and/or methods of determining a location of UE 104 may be provided. A user may opt-in or agree to share location information acquired via module 106 with ECEBM 120 for the purposes of receiving relevant offers upon entering a merchant location and/or being in close proximity thereto.

In some embodiments, module 106 may share longitude and latitude information, GPS data, location data, or the like, to ECEBM 120 via network 102. ECEBM 120 may analyze and/or translate the location or geographic information received from UE 104 to determine a user's proximate location so that electronic coupons and/or gift cards usable at a merchant in close proximity to thereto may be pushed or otherwise broadcast to the potential buyer via UE 104. In some embodiments, location information may be temporarily stored in a storage element (e.g., 124C) residing at ECEBM 120 and/or accessible by ECEBM 120. The location information in the storage element may be periodically updated, where desired.

In some embodiments, UE 104 includes a digital wallet stored thereon that is managed by UWPM 108. UWPM 108 manages the individual user profile associated with UE 104 for making purchases and/or completing transactions using information stored within the digital wallet of UE 104. For example, UWPM 108 manages the storage and retrieval of various content (e.g., payment cards, certificates, etc.) in a digital wallet to make purchases. UWPM 108 can manage the storage and retrieval of various content stored in one or more storage elements or repositories of the digital wallet.

In some embodiments, UWPM 108 includes at least a first storage element 110A having a collection of electronic certificate(s) in a user's digital wallet, a second storage element 1108 including records relating to a user's purchase history (e.g., by merchant ID, purchase amount, or the like), and/or a third storage element 110C including a collection of a user's payment card(s) used to make purchases. That is, the first storage element 110A may include identifiers (IDs) associated with electronic certificates such as coupons, gift cards, offers, rewards, or the like. These certificates may be offered for sale and/or exchange, and broadcast to other subscribers.

In some embodiments, a buyer may also “opt-in” and/or agree share purchase history information disposed in second storage element 1108. In exchange for sharing such information, ECEBM 120 may broadcast relevant offers regarding electronic certificates for sale to a potential buyer via UE 104 or other wise notify the potential buyer relevant offers. Subscribers may agree to share information regarding their personal purchase history from second storage element 1108 with ECEBM 120, so that ECEBM 120 can analyze the information and configure a pool of potential buyers for relevant offers. Purchase history information stored in element 1108 may include any information regarding past purchases, such as the day of a purchase (e.g., Mon., Tues., etc.), the date of a purchase (e.g., DD/MM/YYYY), the time of a purchase, the merchant identifier where a purchase was made, an amount of a purchase, or the like. Such information may be analyzed so that electronic certificates being offered for sale from digital wallet are broadcast or sent to buyers that may have an interest in purchasing such.

For example, where a subscriber's purchase history includes information regarding purchases made at a veterinarian's office and a pet day-care, this subscriber may be notified or broadcast when electronic certificates to a pet store are available. In other embodiments, where a subscriber's purchase history includes information regarding multiple purchases from a specific merchant (e.g., Target®, Amazon®, or the like), this subscriber may be notified or broadcast when electronic certificates to that specific merchant are available. In some embodiments, purchase history information may also be stored in a storage element (e.g., 124C) residing at ECEBM 120 and/or accessible by ECEBM 120. The purchase history in the storage element may be periodically updated, where desired.

In some embodiments, ECEBM 120 includes an Exchange and Bidding matching Engine (EBME) 122 configured to access buyer preferences stored in a first storage element 124A, seller preferences stored in a second storage element 124B, and subscriber data (e.g., location information, purchase history, or the like) in third storage element 124C.

Still referring to FIG. 1 and in some embodiments, architecture 100 further comprises a wallet manager 112. Wallet manager 112 may include a server configured to maintain and manage the contents associated with a plurality of digital wallets. For example, wallet manager may include a first repository having a plurality of wallet IDs 114A stored therein, and a second repository having a plurality of electronic certificate IDs 114B stored therein. The wallet IDs 114A can be linked, cross-referenced with, or otherwise associated with the electronic certificate IDs so that a wallet manager 112 is aware of which certificate IDs reside in which wallet IDs. Where an electronic certificate is sold from one subscriber to another, wallet manager 112 may receive instructions from ECEBM 120 to transfer an electronic certificate having a first ID from a first digital wallet to a second digital wallet, thereby providing a secure wallet-to-wallet exchange of electronic certificates.

In operation, wallet manager 112 also provides services for users (e.g., buyers, sellers, subscribers, or consumers) for setting up and maintaining digital wallets. For example, wallet manager 112 can provide a graphical user interface (GUI) to UEs 104 of buyers and sellers for setting up digital wallets, e.g., by collecting personal and financial information form users and storing the personal and financial information in various storage elements (e.g., 110A, 110C, 114A, 114B, etc.). ECEBM 120 is configured to analyze information regarding the sale of an electronic certificate, including buyer and seller preference information, and communicate instructions to wallet manager 112 instructing manager 112 to securely transfer an electronic certificate from one digital wallet to another digital wallet upon a sale.

Wallet manager 112 may securely manage the exchanges between digital wallets. Wallet manager 112 can transfer various assets between digital wallets over packet-based network 102, including the transfer of electronic certificates. Transferring an electronic certificate may include deleting the electronic gift card from the transferring digital wallet, adding the electronic gift card to the receiving digital wallet, and notifying any other appropriate parties such as an electronic certificate manager 116, merchant server 130, or electronic certificate provider 132, where necessary. Transferring electronic certificates between digital wallets of subscribers is seamless, and can be performed in real-time, for example, as one subscriber is within a merchant location and/or purchasing goods or services at a point of sale (POS).

In some embodiments, ECEBM 120 can initiate a payment for an electronic certificate using a payment network or payment authentication system 128 configured to provide for the authentication and transfer of money from one digital wallet in exchange for an electronic certificate in another digital wallet. Payment authentication systems 128 may include payment servers configure to authenticate purchases between issuing and acquiring financial entities. Payment networks may use a variety of different protocols and procedures in order to process the transfer of money for various types of transactions. Transactions that may be performed via a payment network may include product or service purchases, credit purchases, debit transactions, fund transfers, account withdrawals, and the like. Payment networks may be configured to authorize and perform transactions via cash or cash-substitutes, which may include payment cards, financial accounts, and the like.

In some embodiments, systems 128 include one or more servers configured to authenticate users to other services in architecture 100. In some examples, authentication systems 128 may be associated with a particular financial institution for providing a centralized authentication service for various financial transactions. UEs 104 can authenticate to authentication systems 128, e.g., using biometric authorization on UEs 104, or by providing user credentials. In some embodiments, payment authentication system 128 includes a mobile application, platform, or service that is owned and operated by MasterCard® International Incorporated of Purchase, N.Y., USA. Payment authentication system 128 may include a service offered via MasterCard®, or any other service infrastructure.

Still referring to FIG. 1, architecture 100 may further comprise one or more electronic certificate managers 116 configured to manage electronic certificates. In operation, certificate managers 116 are servers configured to maintain and manage an inventory of electronic certificates. This may be embodied, for example, via databases of active certificates 118 so that expired certificates cannot be redeemed. Electronic certificate manager 116 may update certificate inventory upon use of an electronic certificate.

Architecture 100 further comprises at least one broadcast service provider 126. In operation, ECEBM 120 transmits a plurality of subscriber identifiers and offer details regarding a sale of one or more electronic certificates to broadcast service provider 126. The plurality of identifiers may include, for example, identifiers associated with potential buyers of the one or more electronic certificates. The identifiers may include, for example, any form of identifier, such as for example only, an international mobile subscriber identity (IMSI), an internet protocol (IP) address, a unique subscriber ID, or the like. Upon receiving the identifiers and offer details, broadcast service provider 126 sends a broadcast to prospective buyers notifying them of the sale of an electronic certificate. The broadcast may be embodied as a text message, alert message, electronic message, or the like, optionally appearing on a graphical user interface of UE 104.

ECEBM 120 is configured to receive packets encoded with payload information regarding offers for sale of one or more electronic certificates residing in a first digital wallet, analyze location and geographic information, analyze purchase history information, and/or analyze buyer preferences to configure a pool of buyers, instruct broadcast service provider 126 to notify potential buyers of the offer for sale, match buyers with sellers, instruct payment authentication system 128 to authorize the transaction and sale of an electronic certificate, and instruct wallet manager 112 to initiate the secure transfer of an electronic certificate from one digital wallet to another. Wallet manager 112 may also be configured to invoke on or more payment authentication systems 128 to authorize and conduct the payment for the electronic certificate upon receiving instructions from ECEBM 120, where desired. Once authenticated, wallet manager 112 can securely transfer the electronic certificate from the seller's digital wallet to the buyer's digital wallet.

Still referring to FIG. 1 and in some embodiments, architecture 100 further includes one or more merchant servers 130. Merchant servers 130 may include backend servers configured to initiating a payment transaction for a good or service offered by a merchant. UE 104 may receive an electronic certificate from a separate, different digital wallet, and interface with a merchant server 130, such as a physical POS, to initiate a payment for a good or service and/or apply a newly received electronic certificate from the other digital wallet during the transaction via UWPM 108. In other embodiments, a subscriber accessing UE 104 may access merchant server 130 via a website, a mobile application, or the like, and initiate a payment for a good or service via UWPM 108. In this embodiment, merchant servers 130 include at least one merchant server hosted by a seller of goods and/or services (e.g., a company, a corporation, a business, a manufacturer, a supplier, a store, a person, a seller, a retailer, a partnership, or the like). The merchant server 130 may include a POS server configured to complete a POS purchase transaction.

Architecture 100 further comprises one or more electronic certificate providers 132. Electronic certificate providers 132 are configured to issue electronic certificates to UE 104. Electronic certificate providers 132 may issue electronic gift certificates, coupons, offers, rebates, or the like to UE 104. In some embodiments, UE 104 is configured to download one or more electronic certificates obtained from a server hosted by one or more electronic certificate providers 132.

Notably, ECEBM 120 is a special purpose computing system or machine that includes hardware components (e.g., one or more processor units, memory, storage, network interfaces, etc.) configured to execute hardware and software elements (e.g., APIs, packets, engines, etc.) for the purposes of performing one or more aspects of the disclosed subject matter herein. ECEBM 120 and its components and/or functionality described herein improves the technological field pertaining to managing content in digital wallets providing intelligent mechanisms for broadcasting and selling electronic certificates. ECEBM 120 can instruct UE 104 to send subscribers real-time alerts regarding offers to purchase relevant electronic certificates, as a subscriber enters a merchant location and/or is placing items within an electronic “cart” of a specific merchant.

It will be appreciated that FIG. 1 is for illustrative purposes only and that various entities, their locations, and/or their functions described above in relation to FIG. 1 may be changed, altered, added, or removed.

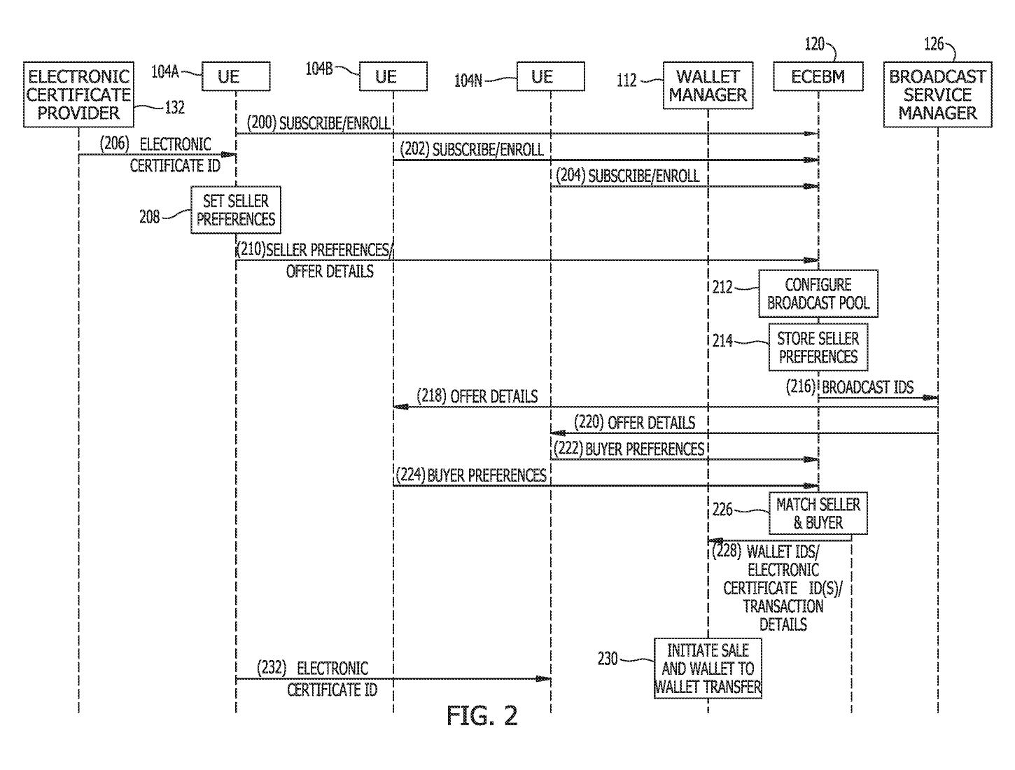

FIG. 2 is a message diagram illustrating exemplary electronic messaging between various parties involved in the broadcast and exchange of electronic certificates between digital wallets according to an embodiment of the subject matter described.

Communications described with respect to FIG. 2 are packet communications having payloads including details regarding an offer to sell one or more electronic certificates, location and/or geographic information associated with a subscriber, purchase history information associated with a digital wallet of a subscriber, subscriber preferences, or metadata corresponding to such information. Communications described with respect to FIG. 2 may also include packets exchanged via an API exchange or call. Communications shown described in regard to FIG. 2 are for exemplary purposes only and the communications may occur in a different order than that shown or described, and some communications may occur simultaneously, or nearly simultaneously.

Referring to FIG. 2, at lines 200 to 204 users utilizing UE 104A to UE 104N (e.g., where “N” is a whole number integer>2) may subscribe and enroll in services offered by ECEBM 120, which may be accessed via a website, a mobile application and/or any user interface programmed to do so. During the enrollment process, users utilizing UE 104A to 104N may set and/or specify preferences, where desired. In some embodiments, users allow ECEBM 120 to access subscriber data including but not limited to location and/or geographic data and purchase history data.

At line 206, an electronic certificate provider 132 sends an electronic certificate having identified by an electronic certificate ID to UE 104A. Any other information (e.g., tracking information, or the like) may also be sent at line 206 to UE 104A.

In response to receiving the electronic certificate, UE 104A may download, save, or otherwise store the electronic certificate, tracking information, and/or the electronic ID in a storage element (e.g., 110A, FIG. 1) associated with the digital wallet. The electronic certificate having the electronic certificate ID may include an electronic gift card, an electronic gift certificate, an electronic coupon, an electronic offer, or the like. In some embodiments a user, which now a subscriber, may decide to sell the electronic certificate. In some embodiments, the subscriber decides to sell and/or exchange the electronic certificate with another subscriber.

At block 208, the subscriber sets or specifies one or more seller preferences associated with selling the electronic certificate. The seller preferences may include, for example, a minimum bid (monetary or non-monetary) the subscriber (seller) is willing to accept in exchange for the electronic certificate, a maximum bid, a guaranteed price (or other consideration) at which the seller is willing to automatically accept in exchange for the electronic certificate, or the like. Other seller preferences set at block 208 may include an expiration date that the offer for sale ends, a merchant identifier, the electronic certificate identifier, the value of the electronic certificate, or the like. The subscriber may utilize a user interface of UE 104A (e.g., a GUI, or the like) to input or specify preferences associated with the sale of an electronic certificate.

At line 210, the seller preferences and offer details are communicated to ECEBM 120.

At block 212 and in response to receiving the seller preferences, ECEBM 120 configures a broadcast pool of potential buyers that may have an interest in receiving a notification regarding the electronic certificate being offered for sale. Configuring a broadcast pool of potential buyers includes analyzing information regarding the electronic certificate for sale (e.g., the merchant ID, the type of certificate, or the like) and subscriber data (e.g., in 124C, FIG. 1) to determine subscribers that should be notified or broadcast details of the sale.

Subscriber data may be received from and stored for every subscriber that subscribes services offered by ECEBM 120. The subscriber data may include data relating to the subscribers digital wallet, location, or the like. The subscriber data received at ECEBM 120 is analyzed and/or filtered for determining (e.g., narrowing down) the subscribers to a pool of potential buyers identified by subscriber identifiers.

Subscriber data may include purchase history information and/or location and geographic information associated with as plurality of subscribers. ECEBM 120 uses intelligence gained from analyzing the subscriber data to target those subscribers that may have an interest in the electronic certificate being offered for sale based upon their purchase history and/or location information. That is, ECEBM 120 applies logic and intelligence in configuring a pool of subscribers to which the sale of the electronic certificate will be broadcast.

At block 214, ECEBM 120 stores the seller preferences received at line 210. The seller preferences will later be examined to match sellers of electronic certificates with buyers of electronic certificates.

At line 216, ECEBM 120 sends a plurality of subscriber identifiers, or broadcast IDs, to a broadcast service manager 126. The broadcast IDs may include any form of subscriber identifier corresponding to one or more UEs that ECEBM 120 determines should receive a broadcast for notifying particular subscribers of the sale of a specific electronic certificate. For example, ECEBM 120 may communicate IMSI's, IP addresses, unique subscriber IDs, combinations thereof, or any other type of identifier to manager 126. For example, in block 212, ECEBM 120 identifies subscribers utilizing UE 104B and UE 104N as potential buyers and part of a broadcast pool. In line 216, identifiers associated with UE 104B and UE 104N are sent to manager 126.

In lines 218 and 220, manager 126 broadcasts details regarding the offer to sell the electronic certificate to a buyer pool including at least UE 104B and UE 104N. The offer details communicated to UE 104B and UE 104N may include some or all of the seller preferences (e.g., a min/max bid, etc.) and details regarding the electronic certificate. For example, the offer details sent to UE 104B and UE 104N may include at least details regarding the electronic certificate for sale, such as where the certificate is redeemable (e.g., a specific merchant or brand), the value of the electronic certificate, tracking information associated with the electronic certificate, the electronic certificate ID, whether the electronic certificate expires, or the like. The offer details may also identify the type of electronic certificate being sold, for example, whether the certificate is a coupon, offer, gift card, gift certificate, or the like.

As lines 222 and 224 respective UE 104N and UE 104B communicate buyer preferences to ECEBM 120. Subscribers utilizing UE 104N and UE 104B may specify buyer preferences using a touch screen interface or any other type of user interface disposed on the respective UE. ECEBM 120 receives the buyer preferences and optionally stores them for analysis (e.g., in 124A, FIG. 1). Buyer preferences may include, for example, a bid for an item for sale, an offer for an item for sale, or any other value or consideration in exchange for the electronic certificate. Buyer preferences may also include, for example, updates to location or geographic information and/or updates in purchase history for use by ECEBM 120 in formulating more targeted broadcasts sent to a broadcast pool of potential buyers.

In block 226, ECEBM 120 analyzes buyer preferences, seller preferences, and any other type of subscriber information for matching a buyer to a seller. That is, ECEBM 120 is configured to determine a specific buyer for a specific electronic certificate disposed in a digital wallet of another user, and initiate the sale and transfer of the electronic certificate from the seller's digital wallet to the buyer's digital wallet. The specific buyer determined by ECEBM 120 may meet, match, and/or exceed the seller preferences specified by the seller. That is, the buyer of the electronic certificate is one that meets or exceeds the seller's minimum bid, guaranteed price, or maximum bid.

In line 228, ECEBM 120 sends wallet IDs associated with the respective buyer's and seller's wallets so that an electronic certificate can be transferred, in real time, by wallet manager 112 from the seller's digital wallet to the buyer's digital wallet. ECEBM 120 also sends the electronic certificate ID and any tracking information to the wallet manager 112 so that the wallet manager can transfer the correct electronic certificate from the seller to the buyer. In one embodiment, ECEBM 120 also sends the transaction details (e.g., the purchase amount, the date/time of purchase, etc.) to the wallet manager 112. In other embodiments, ECEBM 120 sends the transaction details to one or more payment authentication systems (e.g., 128, FIG. 1).

In block 230, wallet manager 112 initiates the sale and wallet-to-wallet transfer of the electronic certificate from the seller's digital wallet in UE 104A to the buyer's digital wallet in UE 104B. In some embodiments, wallet manager 112 changes the association between electronic certificate and the subscriber ID or creates a new association between the electronic certificate and the buyer's subscriber ID. Wallet manager 112 may optionally contact an electronic certificate manager (e.g., 116), where desired, to update certificate information or inventory.

In line 232, the electronic certificate corresponding to the electronic certificate ID is transferred, moved, or exchanged from the digital wallet associated with UE 104A to the digital wallet associated with UE 104N. The subscriber (buyer) associated with UE 104N now has access to the electronic certificate that previously resided in the digital wallet associated with UE 104A. The subscriber (buyer) may utilize UE 104N to access the purchased electronic certificate via the buyer's digital wallet.

It will be appreciated that FIG. 2 is for illustrative purposes only and various messages (communications), message sequencing, and/or message content described above in relation to FIG. 2 may be changed, altered, edited, or removed where necessary. For example, some messages and/or process steps may be separated or combined into more than one or less than one message. Other messages and/or process steps may occur simultaneously, or in a different order than that shown.

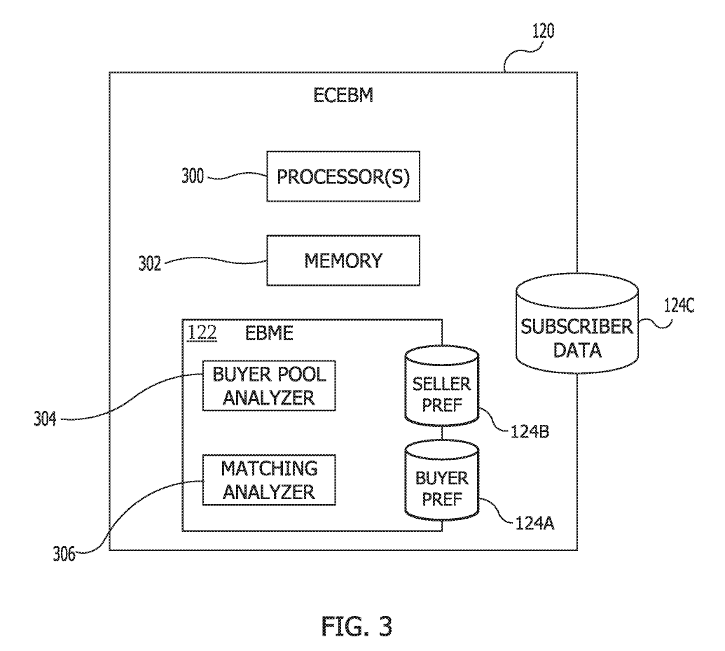

FIG. 3 is a block diagram illustrating an exemplary system for the broadcast and exchange of electronic certificates between digital wallets of subscribers according to an embodiment of the subject matter described herein. FIG. 3 illustrates an embodiment of ECEBM 120, which includes a system for implementing the broadcast and exchange of electronic certificates between digital wallets of subscribers.

In some embodiments, ECEBM 120 includes at least one processor 300 and at least one memory 302 (e.g., a memory component, element or device). ECEBM 120 is configured to utilize processor 300 and memory 302 for executing software to analyze subscriber preferences (e.g., buyer and seller preferences), subscriber data (e.g., location/geographical information and/or purchase history), and/or details regarding a sale of an electronic certificate for matching a buyer with a seller, and initiating the transfer of a digital coupon from the seller's digital wallet to the buyer's digital wallet. In some embodiments, packets or message traffic is sent, received and/or otherwise communicated or exchanged between ECEBM 120 and other network entities according to methods described herein.

In some embodiments, processor 300 includes a microprocessor, such as a central processing unit (CPU), or any other hardware-based processor unit that is configured to execute and/or utilize software to communicate with multiple financial and/or merchant service providers (e.g., or servers associated therewith) for initiating and processing electronic payments, so that clearing and settlement occur upon delivery as opposed to the actual date that the good or service is ordered.

In some embodiments, memory 302 (e.g., a memory element or device) of ECEBM 120 includes a random access memory (RAM), a read only memory (ROM), an optical read/write memory, a cache memory, a magnetic read/write memory, a flash memory, or any other non-transitory storage media. In one embodiment, processor 300 and memory 302 may be used to execute and manage the operation of ECEBM 120. In some embodiments, memory 302 includes any medium that is configured to store (e.g., locally) subscriber data in element 124C, seller preferences in element 124B and/or buyer preferences element 124A. Each element 124A to 124C may include a database, a table, a repository, or any other storage medium configured to store data.

In some embodiments, ECEBM 120 further includes EBME 122 executed by processor 302 and stored in memory 304. EBME 122 may include hardware, software and/or firmware components for analyzing subscriber information at a buyer pool analyzer 304. Buyer pool analyzer 304 analyzes subscriber data 124C, such as location information and/or purchase history information associated with a plurality of subscribers and/or the digital wallets associated therewith, and configures a buyer pool consisting of a plurality of subscriber/buyer IDs. The subscriber/buyer IDs identified by analyzer 304 are associated with subscribers that are logically determined as potentially having the most interest in a specific electronic certificate being sold.

In some embodiments, analyzer 304 analyzes the purchase history associated with the wallets of a plurality of subscribers. Analyzing purchase history may include identifying merchants based on a number of purchases from the merchants in the purchase history of the first digital wallet. Identifying the merchants can include, e.g., determining a number of purchases for each merchant in the purchase history and identifying the merchants having the highest number of purchases in the purchase history, or a number of merchants having a number of purchases above a threshold number of purchases. Where an electronic certificate to a specific merchant (e.g., Merchant X) is for sale, buyers having the most purchases at that specific merchant (e.g., Merchant X) may be identified, added to the buyer pool, and sent a broadcast of the electronic certificate.

In some embodiments, analyzer 304 analyzes the location and geographic information associated with the wallets of a plurality of subscribers. Analyzing location and geographic information may include receiving location information and determining whether a user is in close proximity to a merchant location. Analyzer 304 may also determine whether a user, via the digital wallet, have initiated a purchase or configured items into an electronic “cart” with a respective merchant. Where certain criteria are met, the buyer may be added to the buyer pool and sent a broadcast notification regarding an electronic certificate that is for sale.

EBME 122 may also include hardware, software and/or firmware components for analyzing subscriber information at a matching analyzer 304. Matching analyzer 306 is configured to search and analyze seller preferences 124B and buyer preferences 124A to match a seller of an electronic certificate with a buyer. Upon being matched by analyzer 306, ECEBM 120 initiates the wallet-to-wallet transfer by instructing wallet manager (112) to remove the certificate ID from the seller's digital wallet and add the certificate ID to the buyer's wallet.

Although FIG. 3 depicts ECEBM 120 as a single node or network element, ECEBM 120 may further include a plurality of network elements, a plurality of network components, etc., without departing from the scope of the instant subject matter. In some embodiments, ECEBM 120 initiates the exchange and transfer of content between digital wallets via any suitable components or even multiple hardware components. That is, ECEBM 120 may include multiple processors, memory elements, interfaces, or the like, where desired.

Notably, ECEBM 120 is a special purpose computer, system, and/or machine that includes hardware components (e.g., one or more processor units, memory, and network interfaces) configured to execute hardware and software elements (e.g., APIs, packets, analyzers, modules, etc.) for the purposes of performing one or more aspects of the disclosed subject matter herein. In addition, it should be noted that ECEBM 120 and its components and/or functionality described herein constitute a special purpose computer that improves the technological field pertaining to securely transferring content from one digital wallet to another digital wallet.

It will be appreciated that FIG. 3 is for illustrative purposes only and that various components, their locations, and/or their functions described above in relation to FIG. 3 may be changed, altered, added, integrated, segregated, or removed. For example, some components and/or functions may be separated or combined into more than one entity.

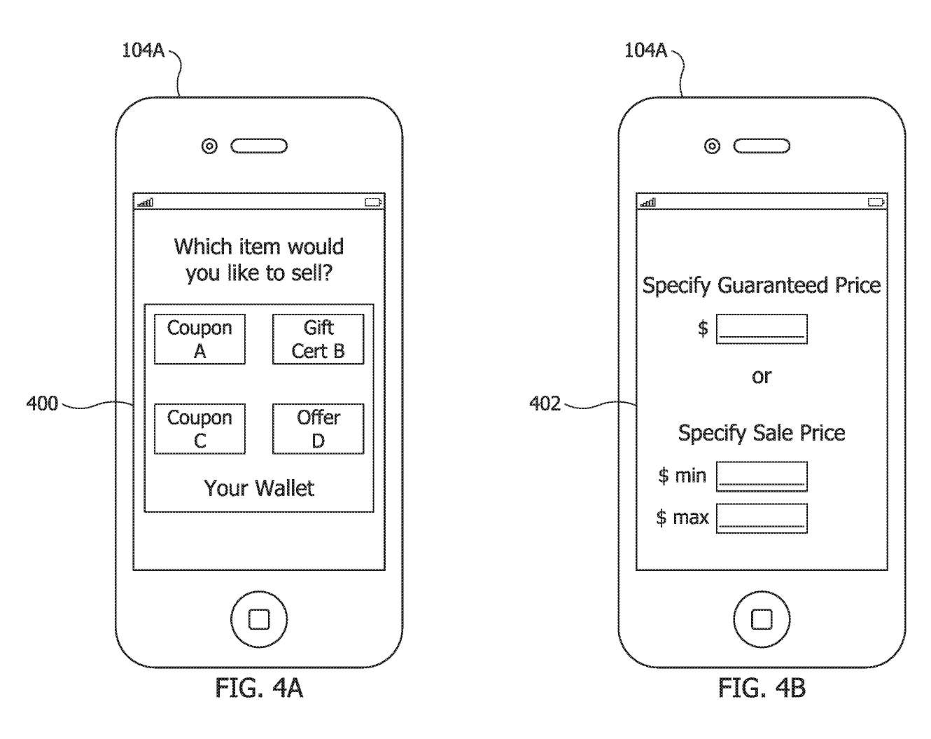

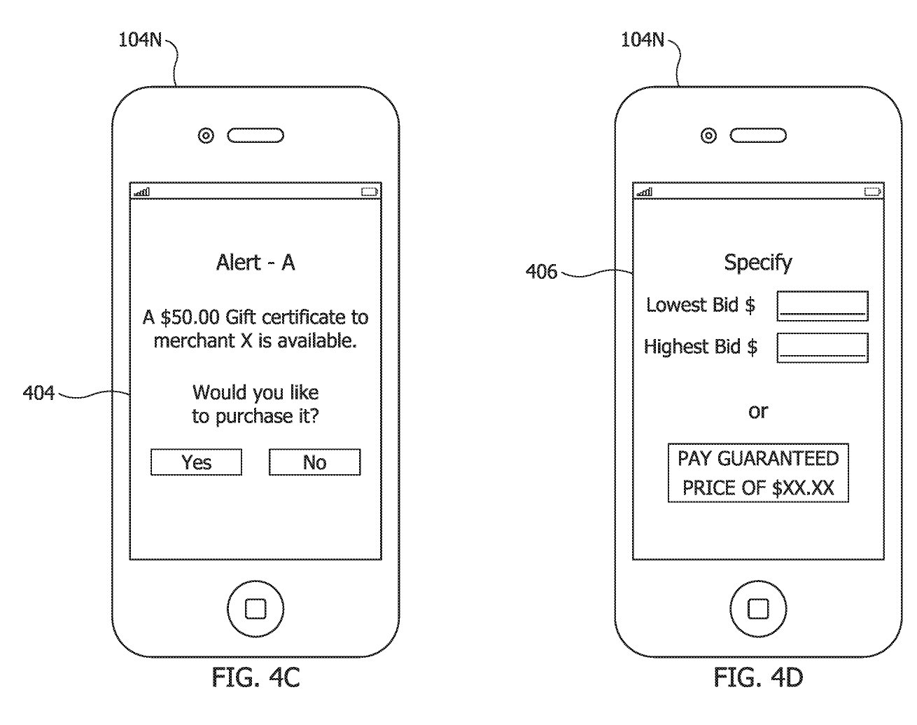

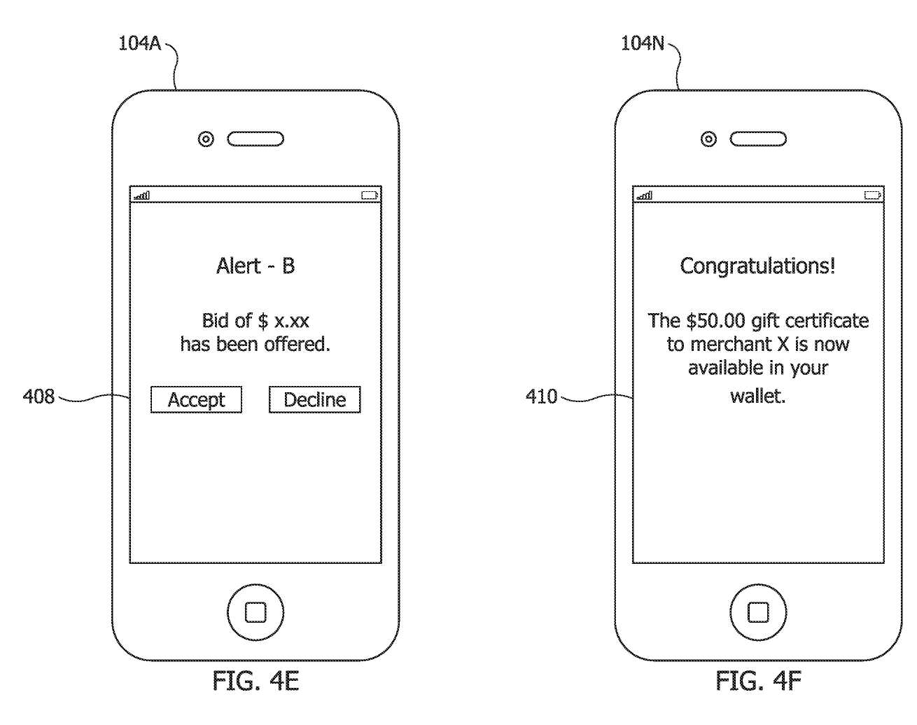

FIGS. 4A-4F are screen shots illustrating a subscriber seller utilizing UE 104A and a subscriber buyer utilizing UE 104N interacting with ECEBM 120. The schematic screen shots in FIGS. 4A-4F illustrate show how subscribers perceive the sale, bidding, and exchange of an electronic certificate residing in a subscriber seller's digital wallet. The screens can be displayed on user devices 104A and 104N and the respective devices are configured to communicate with ECEBM 120 over a packet-based data communications network (102, FIG. 1) to carry out the bidding, sale, transfer, and/or exchange of electronic certificates.

FIG. 4A shows a screen 400 appearing on a subscriber seller's UE 104A. The subscriber seller accesses their respective digital wallet and selects an electronic certificate to sell from a list of certificates.

FIG. 4B shows a screen 402 that prompts the subscriber seller to specify seller preferences. For example, seller preferences may include the minimum and maximum selling prices, or a guaranteed price. An electronic certificate identifier associated with the certificate selected by the subscriber, and any details associated therewith (e.g., the merchant, value, etc.) and the seller preferences are sent to ECEBM 120.

FIG. 4C shows a screen 404 displaying a broadcast notification notifying a subscriber and potential buyer (i.e., a member of a buyer pool) that an electronic certificate in the form of a $50.00 gift certificate to merchant X is for sale. The screen 404 prompts the subscriber and potential buyer to indicate whether they would like to purchase the electronic certificate residing in the subscriber seller's digital wallet.

FIG. 4D shows a screen 406 prompting a subscriber and potential buyer to specify buyer preferences, including a lowest bid, a highest bid, or whether or not to pay the guaranteed price.

FIG. 4E shows a screen 408 notifying a subscriber seller that a bid for the electronic certificate has been made, and the screen 408 prompts the subscriber seller to either accept or decline the bid. Where the bid is accepted, the buyer may select and utilize payment cards residing in their respective digital wallet to complete the purchase (not shown). The payment is authorized, authenticated, and money will move from the buyer to the seller's wallet, account, or the like.

FIG. 4F shows a screen 410 notifying the subscriber/buyer that they have successfully purchased the electronic certificate from the seller. The screen 410 notifies the subscriber/buyer that the electronic certificate is now available in the subscriber/buyer's respective digital wallet.

It will be appreciated that FIGS. 4A to 4F are for illustrative purposes only and various screens, communications, message sequencing, message content, and/or prompting described above in relation to each FIG. may be changed, altered, edited, or removed where necessary.

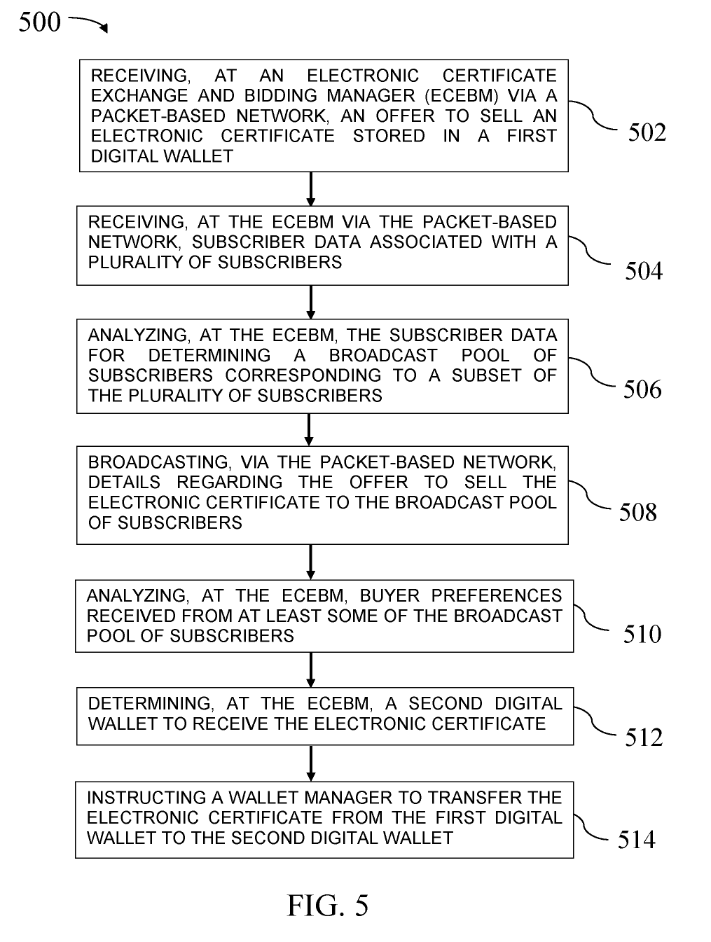

FIG. 5 is a flow chart of an exemplary method 500 for facilitating the exchange and bidding of electronic certificate between digital wallets. Method 500 is performed by a system of one or more computers configured, by virtue of appropriate programming, to publish the contents of a subscriber's digital wallet and facilitate the bidding and exchange of an electronic certificate from one digital wallet to another. For example, the ECEBM 120 of FIG. 1 can perform method 500.

At 502, an ECEBM receives, via a packet-based network, an offer to sell an electronic certificate stored in a first digital wallet. In some embodiments, the offer to sell an electronic certificate includes information associated with the electronic certificate (e.g., a value, a merchant identifier, etc.), seller preferences, or the like.

At 504, the ECEBM receives, via the packet-based network, subscriber data associated with a plurality of subscribers. In some embodiments, the subscriber data includes purchase history associated with a plurality of digital wallets for a plurality of subscribers. In other embodiments, the subscriber data includes location and geographic information associated with a plurality of UEs.

At 506, the ECEBM analyzes the subscriber data for determining a broadcast pool of subscribers corresponding to a subset of the plurality of subscribers. In some embodiments, analyzing the subscriber data includes analyzing purchase history associated with the wallets associated with each member of the broadcast pool of subscribers.

Analyzing purchase history includes include identifying one or more merchants based on a number of purchases from the one or more merchants in the purchase history of the digital wallets. Identifying the merchants may include, e.g., determining a number of purchases for each merchant in the purchase history and identifying the merchants having a highest number of purchases in the purchase history, or a number of merchants having a number of purchases above a threshold number of purchases. Where an electronic certificate to a specific merchant (e.g., Merchant X) is for sale, buyers having the most purchases at that specific merchant (e.g., Merchant X) are identified, added to the buyer pool, and sent a broadcast of the electronic certificate.

In some embodiments, the location and geographic information associated with the wallets of a plurality of subscribers is analyzed. Analyzing location and geographic information may include receiving location information and determining whether a user is in close proximity to a merchant location. Analysis may also determine whether a subscriber, via the digital wallet, has initiated a purchase at a merchant.

At 508, a broadcast is sent, via the packet-based network, to the broadcast pool of subscribers. The broadcast may be sent in response to ECEBM instructing a broadcast manager to send a broadcast to a plurality of subscribers associated with a plurality of subscriber identifiers (e.g., mobile numbers, IP addresses, or the like). The broadcast includes details regarding the offer to sell the electronic certificate. Such details may include, for example, tracking information, an electronic certificate ID, a merchant ID for redeeming the certificate, a value of the certificate, or the like.

At 510, the ECEBM analyzes buyer preferences received from at least some of the broadcast pool of subscribers. Buyer preferences may include, for example, maximum and/or minimum bids for purchasing the electronic certificate that is for sale.

At 512, the ECEBM determines a second digital wallet to receive the electronic certificate. The second digital wallet may be accessed by a subscriber desiring to purchase the electronic certificate for sale. ECEBM may determine the second digital wallet via matching seller and buyer preferences. Where a buyer's preferences meet or exceed the seller's preferences (requirements), a notification may be sent to the seller. The seller may accept or deny the buyer's offer to purchase the electronic certificate.

At 514, the ECEBM instructs a wallet manager to transfer the electronic certificate from the first digital wallet to the second digital wallet

As noted above, ECEBM and/or functionality described herein constitute a special purpose computer. It will be appreciated that ECEBM and/or functionality described herein can improve the technological field pertaining to packet communications and/or security, authentication, and speed thereof.

While the subject matter has been has been described herein in reference to specific aspects, embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method for the broadcast and exchange of electronic certificates between digital wallets, the method comprising:
receiving, at an electronic certificate exchange and bidding manager (ECEBM), an offer to sell an electronic certificate stored in a first digital wallet;
receiving, at the ECEBM, subscriber data associated with a plurality of subscribers;
analyzing, at the ECEBM, the subscriber data for determining a broadcast pool of subscribers corresponding to a subset of the plurality of subscribers;
broadcasting details regarding the offer to sell the electronic certificate to the broadcast pool of subscribers;
analyzing, at the ECEBM, buyer preferences received from at least some of the broadcast pool of subscribers;
determining, at the ECEBM, a second digital wallet to receive the electronic certificate; and
instructing a wallet manager to transfer the electronic certificate from the first digital wallet to the second digital wallet.

2. The method of claim 1, wherein receiving an offer to sell an electronic certificate includes receiving an offer to sell an electronic gift card, an electronic coupon, an electronic offer, or an electronic reward.

3. The method of claim 1, wherein receiving an offer to sell an electronic certificate includes receiving seller preferences associated with the offer to sell the electronic certificate.

4. The method of claim 3, wherein the seller preferences include an indication of a minimum monetary bid, a maximum monetary bid, or a guaranteed monetary amount that will be accepted as consideration for the electronic certificate.

5. The method of claim 1, wherein receiving subscriber data includes receiving location information, geographic information, global positioning system (GPS) information, a location code, longitude and latitude coordinates, or a zip code.

6. The method of claim 1, wherein receiving subscriber data includes receiving purchase history information for a plurality of wallets associated with the plurality of subscribers.

7. The method of claim 1, wherein analyzing the subscriber data includes analyzing location information or purchase history information associated with the plurality of subscribers.

8. The method of claim 7, wherein analyzing the purchase history information includes determining a number of purchases conducted at each of a plurality of different merchants in the purchase history and identifying merchants having a highest number of purchases in the purchase history.

9. The method of claim 1, wherein broadcasting details to the broadcast pool of subscribers includes instructing a broadcast manager to send an alert message, a notification message, a Short Message Service (SMS) message, a Multimedia Messaging Service (MMS) message, or an electronic mail (e-mail) message to individual subscribers in the broadcast pool of subscribers.

10. The method of claim 1, wherein instructing the wallet manager includes sending a first digital wallet identifier, a second digital wallet identifier, and an electronic certificate identifier to the wallet manager, and instructing the wallet manager to disassociate the electronic certificate identifier with the first digital wallet and associate the electronic certificate identifier with the second digital wallet.

11. A system for the broadcast and exchange of electronic certificates between digital wallets, the system comprising:
at least one processor; and
an exchange and bidding matching engine (EBME) implemented on the at least one processor, wherein the EBME is configured to:
receive an offer to sell an electronic certificate stored in a first digital wallet;
receive subscriber data associated with a plurality of subscribers;
analyze the subscriber data for determining a broadcast pool of subscribers corresponding to a subset of the plurality of subscribers;
broadcast details regarding the offer to sell the electronic certificate to the broadcast pool of subscribers;
analyze buyer preferences received from at least some of the broadcast pool of subscribers;
determine a second digital wallet to receive the electronic certificate; and
instruct a wallet manager to transfer the electronic certificate from the first digital wallet to the second digital wallet.

12. The system of claim 11, wherein the offer to sell an electronic certificate includes an offer to sell an electronic gift card, an electronic coupon, an electronic offer, or an electronic reward.

13. The system of claim 11, wherein the offer to sell an electronic certificate includes seller preferences associated with the offer to sell the electronic certificate.

14. The system of claim 13, wherein the seller preferences include an indication of a minimum monetary bid, a maximum monetary bid, or a guaranteed monetary amount that will be accepted as consideration for the electronic certificate.

15. The system of claim 11, wherein the subscriber data includes location information, geographic information, global positioning system (GPS) information, a location code, longitude and latitude coordinates, or a zip code.

16. The system of claim 11, wherein the subscriber data includes purchase history information for a plurality of wallets associated with the plurality of subscribers.

17. The system of claim 16, wherein the purchase history information includes a number of purchases conducted at each of a plurality of merchants.

18. The system of claim 11, wherein the EBME is configured to determine a number of purchases for each merchant in a purchase history and identify merchants having a highest number of purchases in the purchase history.

19. The system of claim 11, wherein the EBME is configured to instructing a broadcast manager to send an alert message, a notification message, a Short Message Service (SMS) message, a Multimedia Messaging Service (MMS) message, or an electronic mail (e-mail) message to individual subscribers in the broadcast pool of subscribers.

20. The system of claim 11, wherein the EBME is configured to send the wallet manager a first digital wallet identifier, a second digital wallet identifier, and an electronic certificate identifier to the wallet manager, and instruct the wallet manager to disassociate the electronic certificate identifier with the first digital wallet and associate the electronic certificate identifier with the second digital wallet.

21. A non-transitory computer readable medium having stored thereon executable instructions that when executed by the processor of a computer control the computer to perform steps comprising:
receiving, at an electronic certificate exchange and bidding manager (ECEBM), an offer to sell an electronic certificate stored in a first digital wallet;
receiving, at the ECEBM, subscriber data associated with a plurality of subscribers;
analyzing, at the ECEBM, the subscriber data for determining a broadcast pool of subscribers corresponding to a subset of the plurality of subscribers;
broadcasting details regarding the offer to sell the electronic certificate to the broadcast pool of subscribers;
analyzing, at the ECEBM, buyer preferences received from at least some of the broadcast pool of subscribers;
determining, at the ECEBM, a second digital wallet to receive the electronic certificate; and
instructing a wallet manager to transfer the electronic certificate from the first digital wallet to the second digital wallet.
